(19) United States
(12) Patent Application Publication
(10) Pub. No.: US 2010/0079734 A1
(43) Pub. Date: Apr. 1, 2010

(54) Projection Apparatus with Filter

(76) Inventors: Henning Rehn, Berlin (DE); Michael Willacker, Oranienburg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/444,565

(22) PCT Filed: Oct. 1, 2007
(86) PCT No.: PCT/EP2007/060390

§ 371 Date: Apr. 6, 2009

(51) Int. Cl. G03B 21/14

(52) U.S. Cl. 353/84

(57) ABSTRACT

A projection apparatus comprising a light source, an image display device and at least one filter device for transmitting a first portion of the radiation from the light source in a first wavelength range in the visible range to the image display device, and for diffusely reflecting a second portion of the radiation in a second wavelength range outside the visible range.

### TECHNICAL FIELD

The invention relates to a projection apparatus with filter, in particular for light radiation outside the visible range.

### PRIOR ART

In image projection systems with discharge lamps according to the prior art such as, for example, the image projection system described in WO 07/024120 A1, a discharge lamp is provided with an elliptical reflector, and the radiation passes to an image display system via an ultraviolet filter, infrared filter, that is to say a UV filter or a IR filter or a UV-IR filter. The ultraviolet filter/infrared filter are normally of planar design. An ultrahigh pressure discharge lamp is used as discharge lamp. Owing to the retroreflection of the radiation by the filters to the lamp, it being possible to focus a portion of the light bundle toward the lamp, high temperatures are generated on parts of the lamp that cause a substantial shortening of the service life of the lamp, and can even bring the lamp to burst.

Furthermore, in the prior art use has been made of planar lenses with dichroic coating situated at an angle of 5° to 20° in the beam path. A small angle of attack of the lenses often has the disadvantage of a rise in the risk of a retroreflection onto the lamp. For example, light can be focused onto the front side of the burner, and the power supply present there can be damaged.

### SUMMARY OF THE INVENTION

It is the object of the invention to provide a projection apparatus that enables a long service life of the light source in conjunction with a fully functioning UV/IR blocker.

This object is achieved according to the invention by the features of claim 1.

A projection apparatus with a light source, an image display device and at least one filter device for transmitting a first portion of the radiation from the light source in a first wavelength range in the visible range to the image display device, and for reflecting a second portion of the radiation in a second wavelength range outside the visible range is provided. Owing to the reflection at the inventive surface shape of the UV/IR blocker, the reflected energy is diffusely distributed such that it is possible to avoid locally narrowly restricted overheating at the light source.

The second wavelength range is preferably the range of ultraviolet and/or infrared radiation so that light invisible to the human eye, which can lead to a heating of the light source, can be filtered out before entry into the image display device.

According to one embodiment, the light source is a discharge lamp, preferably a high pressure discharge lamp, as a result of which, in addition to excellent color reproduction and a long service life, extremely large light quantities required for projection applications can be achieved in a very small space.

It is preferred for the filter device to have a curved surface that can diffusely distribute the energy reflected by the filter device.

It is advantageous when the curved surface, pointing toward the light source, of the filter device is concave from the point of view of the light source.

It is possible to provide an integrator between the at least one filter device and the image display device such that a homogeneous light distribution can be emmitted toward the image display device.

Inventive developments are disclosed in the subclaims.

### BRIEF DESCRIPTION OF THE DRAWINGS

The invention is explained in more detail below with the aid of a preferred exemplary embodiment. In the drawing:

FIG. 1 shows a projection apparatus corresponding to a first exemplary embodiment of the present invention, and

FIG. 2 shows a projection apparatus corresponding to a second exemplary embodiment of the present invention.

### PREFERRED DESIGN OF THE INVENTION

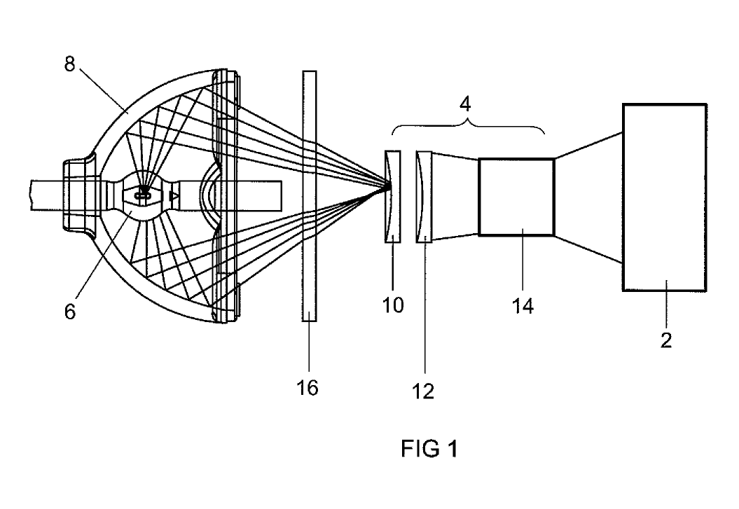

The inventive projection apparatus is now described with reference to the first exemplary embodiment, shown in FIG. 1.

The projection apparatus 1 has an image display system 2, an optical system 4 and a light source 6 with a reflector 8 that focuses the light radiation emitted by the light source 6 away from the optical system 4, that is to say to the left in FIG. 1, and reflects it toward the optical system 4, that is to say to the right in FIG. 1. The reflector 8 has substantially the shape of an ellipsoid, and so the focal point rays of the light source 6 are focused onto the secondary focal point.

The light source 6 in FIG. 1 is a high pressure discharge lamp. A front panel 16 arranged between the reflector 8 and the optical system 4 serves here as explosion protection if the high pressure discharge lamp should explode. However, it is also possible to make use for the light source of any desired lamp that has the characteristics desired for the projection apparatus 1, that is to say other types of discharge lamps as well, for example. The light source 6 emits visible light, infrared light and ultraviolet light. It suffices for the use of the present invention when the light source emits light outside the range visible to humans such as, for example, infrared light or ultraviolet light.

The optical system 4 has an ultraviolet filter 10 (UV filter), an infrared filter 12 (IR filter), an integrator 14 and the remaining projector optics in the form of an image display system 2.

The ultraviolet filter 10 and the infrared filter 12 can be dichroic lenses, and can be of plane-concave design in accordance with the first exemplary embodiment from FIG. 1. The dichroically coated surface has a center of curvature in the direction of the lamp. It follows that the radiation retroreflected by the UV filter and IR filter is not focused onto parts of the lamp, but that the energy reflected by the filters is diffusely distributed and therefore cannot lead to a locally restricted overheating. This is illustrated with the aid of a few representative light rays. It is possible on the basis of the energy diffusely retroreflected by the curved surface to raise the reliability of the system and to reduce the error rate owing to retroreflection, particularly with regard to an overheating at the electrodes. In some circumstances, the outlay on cooling for the projection apparatus is lower, and the cooling can be in a targeted fashion.

The light emitted by the light source strikes the filters 10 and 12 and is led to the image display system 2 via the integrator 14. The light generated by the optical system 4 and having, for example, red, green and blue components is modulated in the image display system in order to display an image on a projection screen.

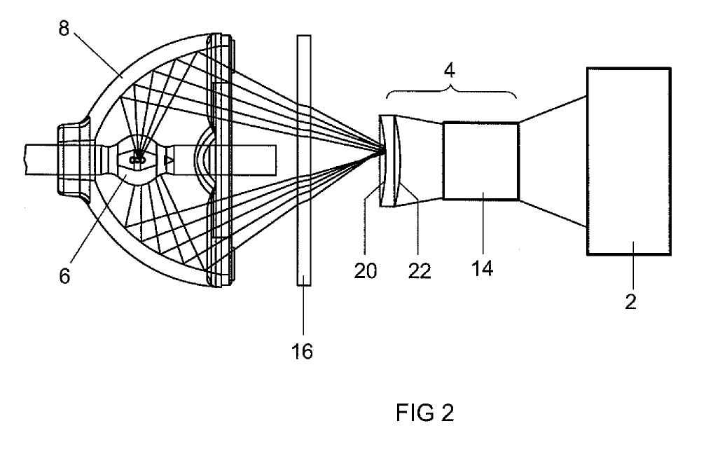

In FIG. 2, a UV coating 20 and an IR coating 22 are applied to the opposite sides of a concave-convex filter. This results in a reduced space requirement for the filter. The configuration of the optical system otherwise corresponds to that of FIG. 1.

As an alternative to this, the UV coating 20 can be applied to a concave-convex filter, and/or the IR coating 22 can be applied to a concave-convex filter.

The present invention is not limited to the simultaneous provision of ultraviolet filter 10 and infrared filter 12—it is, rather, possible to provide only one of these filters in order to effect the diffuse distribution of the reflected energy on the basis of the curved design of such a filter.

The present invention is not limited to the separate provision of UV filter 10 and IR filter 12, it being possible furthermore, for the two filter functions to be combined in one layer.

1. A projection apparatus comprising a light source, an image display device and at least one filter device for transmitting a first portion of the radiation from the light source in a first wavelength range in the visible range to the image display device, and for diffusely reflecting a second portion of the radiation in a second wavelength range outside the visible range.

2. The projection apparatus as claimed in claim 1, wherein the second wavelength range is the range of ultraviolet and/or infrared radiation.

3. The projection apparatus as claimed in claim 1, wherein the light source is a discharge lamp.

4. The projection apparatus as claimed in claim 1, wherein the filter device has a curved surface that can diffusely distribute the energy reflected by the filter device.

5. The projection apparatus as claimed in claim 1, wherein the curved surface provided with a UV/IR coating has a center of curvature in the direction of the lamp when seen from the filter.

6. The projection apparatus as claimed in claim 5, wherein the curved surface is of aspherical, or spherical design.

7. The projection apparatus as claimed in claim 1, wherein an integrator is provided between the at least one filter device and the image display device.

8. The projection apparatus as claimed in claim 1, wherein the filter device is of plane-concave or concave-convex design.

9. The projection apparatus as claimed in claim 3, wherein the light source is a high pressure discharge lamp.

10. The projection apparatus as claimed in claim 6, wherein the curved surface is of conical design.
